(19) United States
(12) Patent Application Publication
(10) Pub. No.: US 2025/0110944 A1
(43) Pub. Date: Apr. 3, 2025

(54) DOCUMENT PREPARATION SUPPORT DEVICE, DOCUMENT PREPARATION SUPPORT METHOD, AND PROGRAM

(71) Applicant: NEC Corporation, Tokyo (JP)

(72) Inventors: Ryosuke WATANABE, Tokyo (JP); Arisa HOZUMI, Tokyo (JP); Yuka SHIGE, Tokyo (JP); Ritsuki ASHIKAWA, Tokyo (JP); Kenji NAGAKURA, Tokyo (JP); Toru FURUKAWA, Tokyo (JP); Ryo SANO, Tokyo (JP); Seiichi WATANABE, Tokyo (JP); Yurina MOMOI, Tokyo (JP)

(73) Assignee: NEC Corporation, Tokyo (JP)

(21) Appl. No.: 18/894,318

(22) Filed: Sep. 24, 2024

(30) Foreign Application Priority Data
Oct. 2, 2023 (JP) 2023-171283

(51) Int. Cl. G06F 16/23; G06F 16/93

(52) U.S. Cl. CPC G06F 16/2365; G06F 16/93

(57) ABSTRACT

A document preparation support device includes a retrieval unit that retrieves a related document corresponding to text included in a document preparation command input by an author, a generation unit that generates a tentative document on the basis of the document preparation command and the retrieved related document, and an extraction unit that, on the basis of the content of a draft document generated from the tentative document by the author, extracts a check item to be reviewed by a document reviewer in the draft document.

### INCORPORATION BY REFERENCE

The present invention is based upon and claims the benefit of priority from Japanese patent application No. 2023-171283, filed on Oct. 2, 2023, the disclosure of which is incorporated herein in its entirety by reference.

### TECHNICAL FIELD

The present disclosure relates to a document preparation support device, a document preparation support method, and a program.

### BACKGROUND ART

Documents handled by the administration involve very important contents and require accuracy. Therefore, it takes a lot of time and efforts in the process from drafting to approval of the documents. In particular, in the process from drafting to approval, since manual work and visual confirmation by humans are mainly performed, it takes time and efforts, which causes a problem of low efficiency.

Meanwhile, automatic generation of documents using a large-scale language model, as described in Patent Literature 1, has been performed recently.
Patent Literature 1: JP 2023-018624 A

### SUMMARY

However, in the case of administrative documents as described above, automatic generation of documents using a language model causes a problem that the accuracy thereof cannot be satisfied sufficiently. Moreover, since a process of approving a draft document is needed, it still takes time and efforts, so that there is a problem of low efficiency. Furthermore, the above-described problem is caused not only in the administrative documents but also in all documents requiring accuracy.

In view of the above, an exemplary object of the present disclosure is to provide a document preparation support device capable of solving the above-described problem, that is, efficiency in preparing documents requiring high accuracy is low.

A document preparation support device, according to one aspect of the present disclosure, is configured to include
a retrieval unit that retrieves a related document corresponding to text included in a document preparation command input by an author,
a generation unit that generates a tentative document on the basis of the document preparation command and the retrieved related document, and
an extraction unit that, on the basis of the content of a draft document generated from the tentative document by the author, extracts a check item to be reviewed by a document reviewer in the draft document.

Further, a document preparation support method, according to one aspect of the present disclosure, is configured to include
retrieving a related document corresponding to text included in a document preparation command input by an author,
generating a tentative document on the basis of the document preparation command and the retrieved related document, and
on the basis of the content of a draft document generated from the tentative document by the author, extracting a check item to be reviewed by a document reviewer in the draft document.

Further, a program according to one aspect of the present disclosure is configured to cause a computer to execute the processing to
retrieve a related document corresponding to text included in a document preparation command input by an author,
generate a tentative document on the basis of the document preparation command and the retrieved related document, and
on the basis of the content of a draft document generated from the tentative document by the author, extract a check item to be reviewed by a document reviewer in the draft document.

With the configurations described above, the present disclosure can improve efficiency in preparing documents requiring high accuracy.

### BRIEF DESCRIPTION OF DRAWINGS

FIG. 1 is a block diagram illustrating a configuration of a document preparation support device according to the present disclosure;

FIG. 2 illustrates an example of a document to be prepared by using the document preparation support device according to the present disclosure;

FIG. 3 illustrates an example of information stored in the document preparation support device according to the present disclosure;

FIG. 4 illustrates an example of information generated by the document preparation support device according to the present disclosure;

FIG. 5 illustrates an example of information generated by the document preparation support device according to the present disclosure;

FIG. 6 illustrates an example of information generated by the document preparation support device according to the present disclosure;

FIG. 7 is a sequence chart illustrating a processing operation of a document preparation supporting system according to the present disclosure;

FIG. 8 is a block diagram illustrating a hardware configuration of a document preparation support device according to the present disclosure; and

FIG. 9 is a block diagram illustrating a configuration of a document preparation support device according to the present disclosure.

### EXAMPLE EMBODIMENTS

### First Example Embodiment

A first example embodiment of the present disclosure will be described with reference to the drawings. Note that the drawings may be related to any embodiments.

### [Configuration]

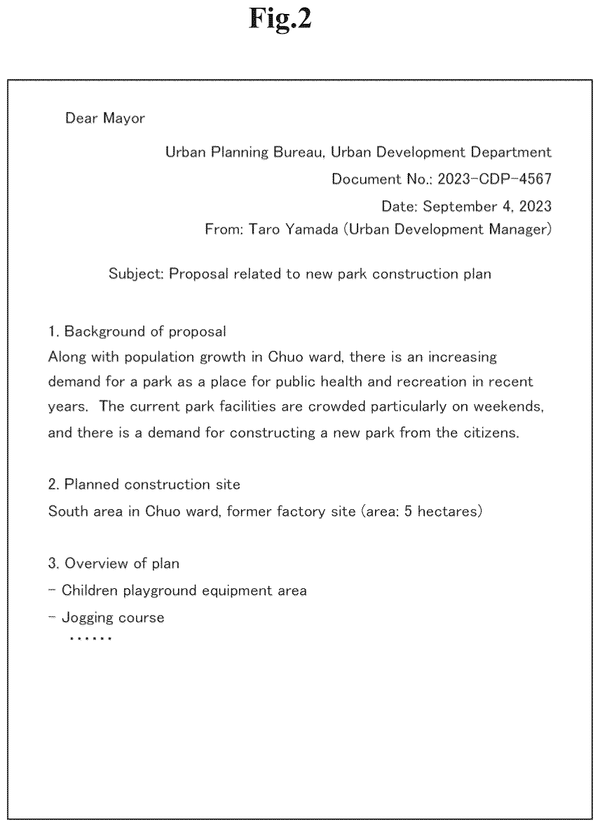

A document preparation supporting system according to the present embodiment is used for supporting an act of preparing documents including a document preparation work by an author who is a person who prepares a document, and a document approval work by a document approver who is a person who reviews and approves the document. Here, documents to be prepared and approved in the present embodiment is, for example, documents describing contents of cases such as planning, measures, and application of projects carried out by the administration, for example. As an example of a document, there is a “draft document” describing the content of a case such as “new park construction plan” as illustrated in FIG. 2, and such a document includes text and sentences representing the contents such as “background of draft”, “planned construction site”, “overview of the plan”, and the like. However, documents supported to be prepared by the document preparation supporting system may be any documents, and are not limited to administrative documents.

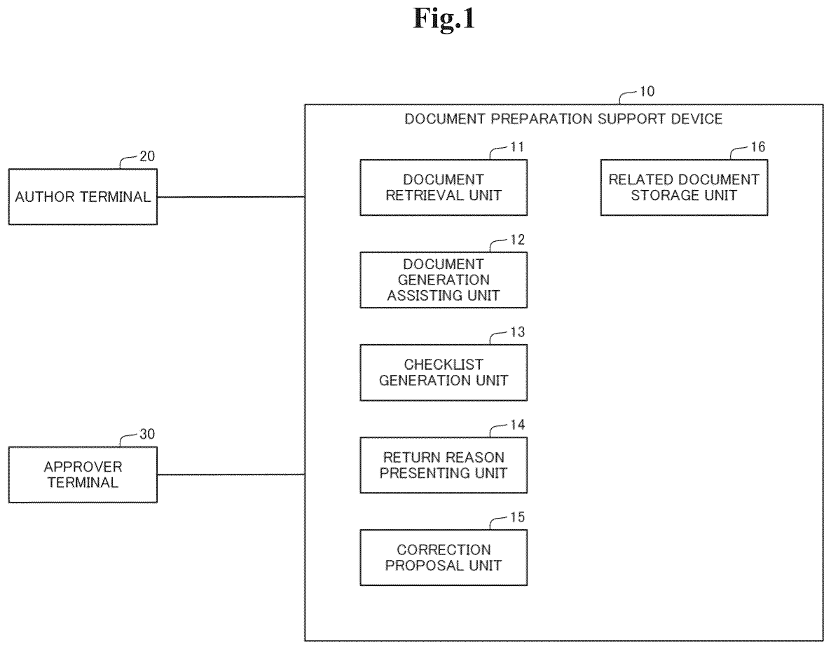

As illustrated in FIG. 1, a document preparation supporting system includes a document preparation support device 10, an author terminal 20, and an approver terminal 30. Each of the author terminal 20 and the approver terminal 30 is configured of an information processing device such as a personal computer, and is connected to the document preparation support device 10 over a network. Hereinafter, the respective constituent elements will be described in detail.

The author terminal 20 has a function of transmitting a document preparation command, input by the author, to the document preparation support device 10, as described below. The author terminal 20 also has functions of displaying, on a display device, a tentative document prepared by the document preparation support device 10 in response to a document preparation command, generating a draft document according to an input of correction data from the author with respect to the tentative document, and requesting the approver terminal 30 for approval via the document preparation support device 10, as described below. The author terminal 20 also has functions of displaying, on a display device, the reason for return with respect to the draft document returned by the approver, preparing a corrected draft document according to the reason for return, and requesting the document preparation support device 10 for generation of a correction proposal according to the reason for return, as described below. Note that the functions of the author terminal 20 will also be described together with the functions of the document preparation support device 10 described below.

The approver terminal 30 has functions of displaying, on a display device, a draft document generated by the author and a checklist generated by the document preparation support device 10, and accepting a checking result and a request for return by the approver with respect to the draft document. For example, the approver terminal 30 accepts designation of a text part determined that correction or review is required in the draft document by the approver. Then, the approver terminal 30 returns the draft document together with the designated text part, to the document preparation support device 10. The approver terminal 30 also has a function of performing an approval process when there is no problem in the checked draft document. Note that the functions of the approver terminal 30 will also be described together with the functions of the document preparation support device 10 described below.

The document preparation support device 10 is configured of one or a plurality of information processing devices each having an arithmetic device and a storage device. As illustrated in FIG. 1, the document preparation support device 10 includes a document retrieval unit 11, a document generation assisting unit 12, a checklist generation unit 13, a return reason presenting unit 14, and a correction proposal unit 15. The functions of the document retrieval unit 11, the document generation assisting unit 12, the checklist generation unit 13, the return reason presenting unit 14, and the correction proposal unit 15 can be realized through execution, by the arithmetic unit, of a program for realizing the respective functions stored in the storage device. The document preparation support device 10 also includes a related document storage unit 16. The related document storage unit 16 is configured of a storage device. Hereinafter, the constituent elements of the document preparation support device 10 will be described.

The document retrieval unit 11 (retrieval unit) accepts a document preparation command input by the author, from the author terminal 20. At that time, the document preparation command includes keywords consisting of text related to a case subject to document preparation. For example, in the case of planning preparation of an administrative document as illustrated in FIG. 2, a document preparation command such as “preparing a document related to new park construction plan” or “preparing a plan for constructing a new park” is input, and “new park construction”, “new park”, and the like are included as keywords.

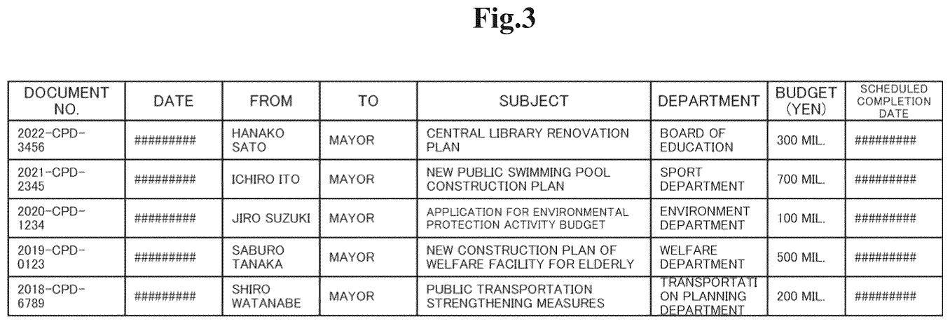

Then, the document retrieval unit 11 retrieves related documents corresponding to the keywords included in the document preparation command, among related documents stored in the related document storage unit 16. Here, in the related document storage unit 16, a database of administrative documents used in the part cases is constructed. In the database of administrative documents, as illustrated in FIG. 3, items such as “Document No.”, “Date”, From” “To”, “Subject”, “Department”, “Budget”, and “Scheduled completion date” for identifying administrative documents are set as illustrated in FIG. 3, and an administrative document corresponding to each “Document No.” is stored. That is, in the example of FIG. 3, administrative documents such as “central library renovation plan”, and “new public swimming pool construction plan” used in the past are stored in the related document storage unit 16.

The related document storage unit 16 also stores therein related documents containing information that may be referred to as materials in the corresponding project when preparing an administrative document. For example, a template describing the basic contents of an administrative document corresponding to a case may be stored as a related document. Further, as a related document, information managed by the administration, for example, a document containing statistical information such as population and land of the local government governed by the administration, may be stored. Further, as a related document, a document containing information such as laws/regulations, rules, and basic knowledge related to cases such as construction plans and urban planning, may be stored. Further, as a related document, a document containing, with respect to preset text, information such as basic knowledge and notes in a document containing such text, may be stored. Note that in the related document storage unit 16, related documents containing contents other than those described above may be stored.

Then, the document retrieval unit 11 retrieves related documents corresponding to the keywords included in the document preparation command, from among related documents such as past administrative documents and laws/regulations stored in the related document storage unit 16. For example, in the above example, corresponding to a keyword such as “new park construction”, plans that are past administrative documents used when constructing parks and other facilities, documents of laws/regulations related to construction of parks and facilities, and documents of basic knowledge and notes related to parks and construction, are retrieved, and the retrieved related documents are extracted from the related document storage unit 16.

The document generation assisting unit 12 (generation unit) supports preparation of an administrative document according to the document preparation command from the author described above. Specifically, the document generation assisting unit 12 generates a tentative document of an administrative document on the basis of a document preparation command from the author and related documents retrieved as described above. As an example, the document generation assisting unit 12 analyzes the structure of a past administrative document that is a retrieved related document, and prepares a tentative document by using the administrative document and making corrections corresponding to the keywords included in the document preparation command according to the structure of the administrative document. As another example, the document generation assisting unit 12 uses a template corresponding to a case that is a retrieved related document, and generates a tentative document by making corrections corresponding to the statistical information of the local government that is a retrieved related document and the keywords.

Then, the document generation assisting unit 12 outputs the generated tentative document so as to display it on the display device of the author terminal 20. At this time, the document generation assisting unit 12 outputs the generated tentative document so as to display it in association with information related to the retrieved related documents, on the display device of the author terminal 20. For example, in the case where a retrieved related document is a past administrative document, the title, date, document No., and the like of the administrative document may be associated with the tentative document, or the administrative document itself may be associated with the tentative document. Moreover, when the related document is a material such as statistical information, the source thereof may be associated with the tentative document, and when the retrieved related document is a document of laws/regulations, basic knowledge, and the like, the articles of the related laws/regulations or basic knowledge may be associated with the tentative document.

When the document generation assisting unit 12 outputs the generated tentative document so as to display it on the display device of the author terminal 20, the document generation assisting unit 12 may output it by giving the reliability of the generated tentative document. At that time, the document generation assisting unit 12 calculates the similarity between the content of the retrieved related document and the content of the generated tentative document as reliability. For example, the document generation assisting unit 12 calculates the reliability to be higher as the content of the tentative document is more similar to the content of the retrieved related document. As an example, the document generation assisting unit 12 calculates the similarity on the basis of a distance between words included in the related document and the tentative document or a distance between the documents, and calculates it as reliability. However, any method may be used for calculating the reliability.

After the tentative document is displayed on the author terminal 20 in this way, the author prepares a draft document with reference to the tentative document. The author may use the tentative document as a draft document as it is, or may correct the text of the tentative document to prepare a draft document. At that time, the author may refer to the related documents associated with the tentative document, or correct the tentative document with reference to the reliability. Further, the author may prepare an attached document to be attached to the draft document with reference to the tentative document and the related document. Then, the author requests approval of the prepared draft document from the author terminal 20 to the approver terminal 30 via the document preparation support device 10. When requesting approval, the author terminal 20 makes a request for approval by transmitting the related document associated with the tentative document and the prepared attached document to the document preparation support device 10 in association with the prepared draft document.

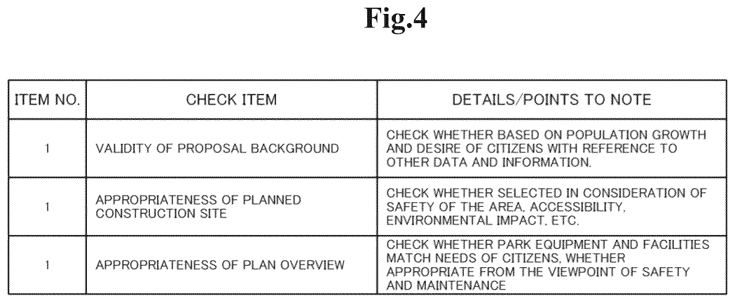

The checklist generation unit 13 (extraction unit) receives a request for approval of the draft document from the author terminal 20 to the approver terminal 30, and transmits the draft document to the approver terminal 30 to request approval. At this time, the checklist generation unit 13 extracts the check items in the draft document based on the content of the draft document to generate a checklist that is a list of the check items for supporting the approval work of the approver. As data of the checklist, as illustrated in FIG. 4, “check item No.” for identifying the check item, “check item” representing the content of the check item, and “details/points to note” representing the content to be checked and points to note are set.

Specifically, when a related document is associated with the draft document, the checklist generation unit 13 generates a checklist with reference to the related document. For example, when additional information related to correction such as a past correction record or correction comments is attached to the related document, the part of the draft document corresponding to the part to which the additional information is given is extracted as a check item. For example, when a correction record or comments are attached to the “background” item in the past related document, the “background” item in the draft document is extracted as a “check item”, and generates a sentence of “details/points to note” based on the comments attached to the related document. When the basic knowledge or notes with respect to predetermined text are included in the related document, the checklist generation unit 13 may extract text in the draft document corresponding to the text of the related document as a check item, and generate a checklist by using the basic knowledge and the notes corresponding to such text as points to note.

As another example, the checklist generation unit 13 extracts a checklist according to the text in the draft document. For example, when there is preset text such as “budget”, “planned site”, or numerical values in the draft document, the checklist generation unit 13 may extract the part corresponding to such text as a “check item”. Moreover, when a sentence describing the basic knowledge or points to note is prepared beforehand in association with the preset text, the checklist generation unit 13 may use such a sentence as a sentence of “details/points to note”. Any method may be used for extraction of a checklist by the checklist generation unit 13.

Then, the checklist generation unit 13 outputs the generated checklist together with the draft document so as to display them on the display device of the approver terminal 30. At this time, the checklist generation unit 13 may transmit the related document and attached materials together with the draft document and the checklist to the approver terminal 30. After the draft document and the checklist are displayed on the approver terminal 30 in this manner, the approver can check the draft document with reference to the checklist. At this time, the approver can check the draft document with reference to the related document associated with the draft document or attached materials attached thereto, together with the checklist.

Then, when there is no inadequacy in the draft document through the check of the draft document, the approver performs processing to approve the draft document by the approver terminal 30. On the contrary, when there is any inadequacy in the draft document, the approver performs processing to designate the inadequate part and performs processing to return the draft document, by the approver terminal 30. For example, the approver selects the text corresponding to the inadequacy in the draft document by the approver terminal 30 to perform input of designating the inadequate part (indicated part), and inputs the inadequate content by the text describing the inadequate content with respect to the inadequate part, and performs operation of return processing of the draft document. For example, when there no detailed address in the item of “planned construction site” in the draft document, the approver designates the text “planned construction site” as an inadequate part, inputs “detailed address is unclear” as the inadequate content, and performs an operation to return it. Then, the approver terminal 30 generates a return document containing the inadequate item indicating the inadequate part of the draft document and the inadequate content, transmits the return document and the draft document to the document preparation support device 10, and requests return to the author terminal 20. At this time, the approver terminal 30 requests the return by transmitting the return document and the draft document while associating them with the related document and the attached material, to the document preparation support device 10. Note that the approver may only designate the inadequate part with respect to the draft document, and it does not have to input the inadequate content. In that case, only the inadequate part may be added to the return document.

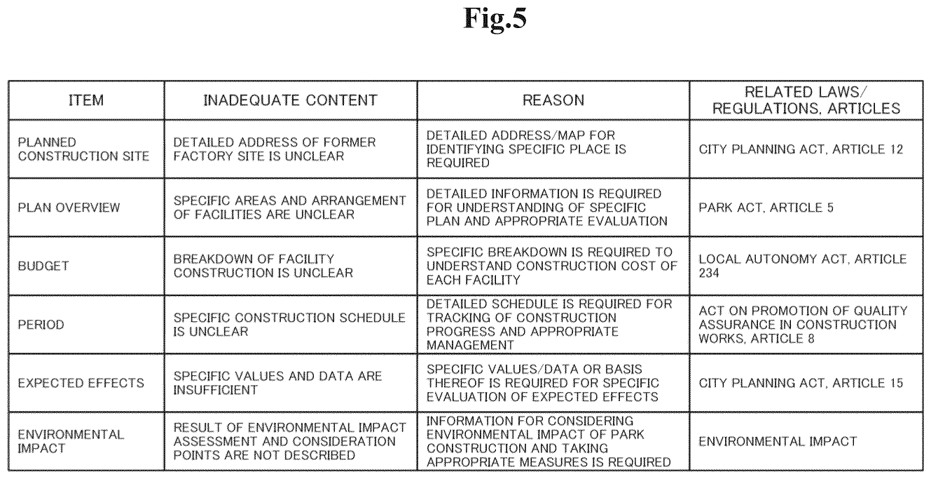

The return reason presenting unit 14 (reason generation unit) receives a request for return from the approver terminal 30 as described above, and generates reason for return (reason for pointing out) describing the reason and background of the inadequacy with respect to the inadequate part and the inadequate content included in the return document. At this time, the return reason presenting unit 14 generates the reason for return according to the inadequate part and the inadequate content included in the return document, for example, content of the text of the inadequate part and the inadequate content. As data of reason for return, as illustrated in FIG. 5, “inadequate item” indicating the item corresponding to the inadequate part, “inadequate content” describing the content of inadequacy, “reason for inadequacy” representing the reason for inadequacy, and “lows/regulations and articles” representing the laws/regulations and articles related to the content of inadequacy.

Specifically, when the draft document requested to be returned as described above is associated with a related document, the return reason presenting unit 14 refers to the related document to generate the reason for inadequacy corresponding to the inadequate item and inadequate content included in the return document. For example, when additional information related to correction such as a correction record, correction comments, and related articles are attached to the past related document, the return reason presenting unit 14 generates the reason for inadequacy or laws/regulations and articles with respect to the inadequate item corresponding to the attached part of the additional information. As an example, when a specific address or a map is attached as a correction history to the “planned construction site” item or reason for correction as comments or laws/regulations and articles are attached in the past related document, the return reason presenting unit 14 generates the reason for inadequacy such as “detailed address or map is required” or laws/regulations and articles such as “City Planning Act, article 12” as illustrated on the first row in FIG. 5. When the basic knowledge or notes with respect to predetermined text are included in the related document, the return reason presenting unit 14 may generate reason for inadequacy with respect to the inadequate item in the draft document by using such basic knowledge or notes.

As another example, the return reason presenting unit 14 generates the reason for inadequacy according to the text of the inadequate part and the inadequate content included in the return document. For example, when the text of the inadequate part in the draft document is preset text such as “planned construction site”, “budget”, “period”, or the like, the return reason presenting unit 14 may generate preset reason for inadequacy or laws/regulations and articles corresponding to such text, for example, “detailed address or map is required”, “specific breakdown is required”, “detailed schedule is required”, “ . . . . Law, article No . . . ” or the like as reason for inadequacy or the like corresponding to each inadequate part as illustrated in FIG. 5. The return reason presenting unit 14 may detect loss of data, data shortage, data inconsistency with other parts, or the like with respect to the text of the inadequate part, and generate the reason for inadequacy. Note that generation of reason for inadequacy and laws/regulations and articles by the return reason presenting unit 14 may be performed by any method.

Then, the return reason presenting unit 14 outputs the generated reason for return together with the draft document so as to display them on the display device of the author terminal 20. At this time, the return reason presenting unit 14 transmits the draft document in association with the related document and attached materials to the author terminal 20. After the draft document and the reason for return are displayed on the author terminal 20 in this manner, the author can correct the draft document with reference to the reason for return by the author terminal 20. At this time, the author can correct the draft document with reference to the related document and the attached materials associated with the draft document as well, together with the reason for return.

The author can also request preparation of a correction proposal to the draft document on the basis of the reason for return, from the author terminal 20 to the document preparation support device 10. At that time, the author terminal 20 transmits the draft document together with the reason for return to the document preparation support device 10 to request a correction proposal to the draft document. Note that the author terminal 20 may also transmit the related document and the attached materials associated with the draft document, to the document preparation support device 10.

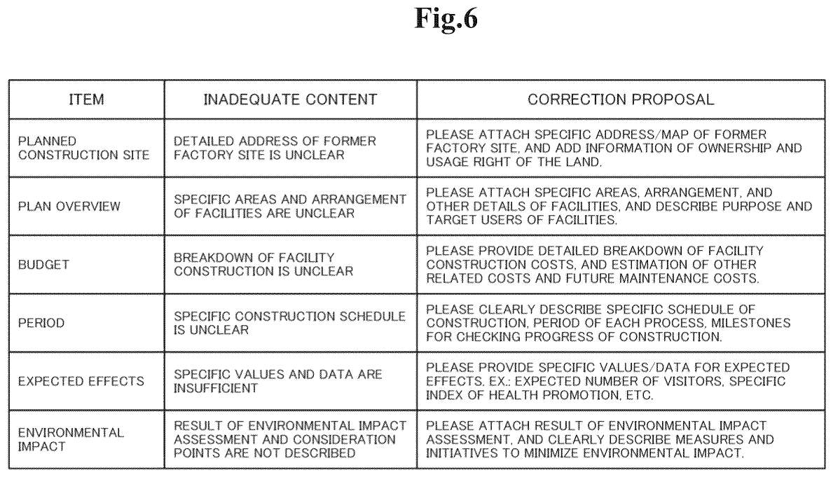

The correction proposal unit 15 prepares a correction proposal based on the reason for return, in response to a request for a correction proposal to the draft document by the author. As data of a correction proposal, as illustrated in FIG. 6, a “correction proposal” describing the content of the correction proposal is set corresponding to the “inadequate item” indicating the item subjected to inadequacy and “inadequate content” representing the inadequate content.

Specifically, when the draft document is associated with the related document, the correction proposal unit 15 refers to the related document to generate a correction proposal corresponding to the reason for inadequacy included in the reason for return. For example, when additional information related to correction such as a correction record, correction comments, and related articles is attached to the past related document, the correction proposal unit 15 generates a correction proposal corresponding to the reason for inadequacy of the inadequate item or inadequate content corresponding to the part to which the additional information is given. As an example, when information such as a specific address or map and ownership is attached as a correction history to the “planned construction site” item in the past related document, or the correction content is attached as comments, the correction proposal unit 15 generates a correction proposal as illustrated on the first row in FIG. 6 as a correction proposal to the reason for inadequacy as illustrated on the first row in FIG. 5.

As another example, the correction proposal unit 15 may generate a correction method by which the content pointed out in the reason for return may be solved, as a correction proposal. For example, when the necessary information is pointed out in the reason for return, the correction proposal unit 15 may generate a correction proposal so as to indicate supplement of such information. Note that generation of a correction proposal by the correction proposal unit 15 may be performed by any method.

Then, the correction proposal unit 15 outputs the generated correction proposal together with the draft document so as to display them on the display device of the author terminal 20. At this time, the correction proposal unit 15 transmits the draft document in association with the related document and attached materials to the author terminal 20. After the draft document and the correction proposal are displayed on the author terminal 20 in this manner, the author can correct the draft document with reference to the correction proposal by the author terminal 20. At this time, the author can correct the draft document with reference to the related document and the attached materials associated with the draft document, together with the correction proposal.

Then, upon correction of the draft document, the author requests approval of the draft document from the author terminal 20 to the approver terminal 30 via the document preparation support device 10. In response to it, as similar to the above description, the document preparation support device 10 prepares a checklist with respect to the draft document, makes an approval request to the approver terminal 30 with the checklist, and when there is return from the approver terminal 30, generates reason for return according to the return, and returns it to the author terminal 20 again.

Here, the functions of the document preparation support device 10 described above, that is, generation of a tentative document by the document generation assisting unit 12, generation of a checklist by the checklist generation unit 13, generation of reason for return by the return reason presenting unit 14, and generation of a correction proposal by the correction proposal unit 15, may be performed by using generative artificial intelligence (AI) such as a language model. That is, the document generation assisting unit 12 or the like is configured to generate a tentative document, a checklist, reason for return, a correction proposal, and the like by using generative AI that is a language model generated by machine learning the database such as related documents generated in the past. Hereinafter, an example of a configuration of performing output by using generative AI by the document generation assisting unit 12 or the like will be described.

First, definition of generative AI (language model) will be described. A language model is a model that learned relationship between words in sentences, and is a model for generating related text related to subject text from subject text. By using a language model having learned text and sentences in various contexts, it is possible to generate related text having reasonable contents related to the subject text. For example, the case of using a language model in question and answer will be described. The language model receives an input of a question “What kind of country is Japan?” as subject text. As an answer to the question, the language model generates text such as “Japan is an island nation in the Northern Hemisphere . . . ” and the like. Note that the learning method of the language model is not limited particularly, but as an example, it may be a model that learned to output at least one sentence including the input text.

As a specific example, a language model is a Generative Pre-training Transformer (GPT) that outputs a sentence including the input text by predicting text having high probability following the input text. Besides, for example, Text-to-Text Transfer Transformer (T5), Bidirectional Encoder Representations from Transformers (BERT), Robustly optimized BERT approach (ROBERTa), Efficiently Learning an Encoder that Classifies Token Replacements Accurately (ELECTRA), and the like are also language models.

The text generated by the language model is not limited to a natural language. The language model may output, for example, an artificial language (program source code and the like) with respect to the text input in a natural language. For example, the language model receives an input of a question “How to acquire data including specific text from a database?” as a subject text. The language model may output a program source code for performing database processing. Alternatively, the language model may output a natural language corresponding to the input text in an artificial language. Moreover, contents generated by the language model is not limited to text. The language model may generate image data, moving image data, voice data, or other data formats corresponding to the input text.

Here, as an example, a processing method of generating a tentative document using the generative AI by the document generation assisting unit 12 will be described. Here, a processing method of generating a tentative document using a past administrative document that is a related document by the generative AI will be described.

First, it is assumed that generative AI includes an acquisition unit, an extraction unit, a rewriting unit, a generation unit, an output control unit, a calculation unit, and a determination unit that are constructed in the arithmetic device of the information processing device.

The acquisition unit of the generative AI acquires data to be input to a language model such as a query input by a user. Here, the acquisition unit acquires text of a document preparation command as data input by the author. Hereinafter, text acquired by the acquisition unit is also referred to as first text. The acquisition unit stores the acquired first text in the storage unit.

The extraction unit of the generative AI extracts a document related to the text. As an example, the extraction unit may extract a document (administrative document prepared in the past or the like) related to the first text, from among the documents stored in the storage unit. In the above example, the extraction unit extracts a past administrative document retrieved according to the keyword as a document related to the document preparation command.

As another example, the extraction unit may extract a document related to the first text from among documents stored in the database connected to the information processing device over the network. The extraction unit stores the extracted document in the storage unit in association with the first text. Note that the method of extracting a document related to the text by the extraction unit is not limited. For example, the extraction unit may extract a document including the text. Moreover, the extraction unit may extract a document related to the text by using an existing search engine.

The rewriting unit of the generative AI rewrites the text. As an example, the rewriting unit rewrites the first text by using the document extracted by the extraction unit. The text rewritten by the rewriting unit is also referred to as second text. The rewriting unit stores the second text in the storage unit in association with the first text. The method of rewriting the text by the rewriting unit is not limited. As an example, the rewriting unit may generate the second text by adding the text written on the document to the first text. As another example, the rewriting unit may generate the second text by adding the text written on the document and the text indicating an additional instruction to the first text. As still another example, the rewriting unit may generate the second text by, after rewriting the first text into text indicating an additional instruction, adding the text written on the document. In the above example, the rewriting unit may generate the second text by adding a document in the past administrative documents to the document preparation command.

The generation unit of the generative AI generates a result of performing natural language processing on the text. As an example, the generation unit generates a result of performing natural language processing on the second text. As described above, the generation unit may use a language model that inputs text therein and outputs a result of performing natural language processing on the text. That is, the generation unit may input the second text to the language model, and generate the result output from the language model as a result of performing the natural language processing on the second text. The result generated by the generation unit is also referred to as a first result. The generation unit stores the generated first result in the storage unit in association with the second text.

The output control unit output a result in which information specifying the document extracted by the extraction unit is added to the first result generated by the generation unit. The output control unit may add information specifying some documents, among a plurality of documents extracted by the extraction unit, to the first result generated by the generation unit. The information specifying a document includes title of the document, author, issue date, and Uniform Resource Locator (URL) indicating the location where the document is stored. The result output by the output control unit is also referred to as a second result.

In addition to the second result, the output control unit may output reliability calculated by the calculation unit to be described below. With such a configuration, the output control unit can present the reliability of the second result to the user.

Further, the output control unit may be configured to output the second result when it is determined by the determination unit, to be described below, that the reliability calculated by the calculation unit exceeds a threshold. With such a configuration, the output control unit can output the second result having high reliability.

The calculation unit calculates the reliability of the result. As an example, the calculation unit calculates the reliability of the first result generated by the generation unit. The calculation unit stores the calculated reliability in the storage unit in association with the first result. With such a configuration, the calculation unit can understand how reliable the first result is.

The method of calculating the reliability of the first result by the calculation unit is not limited. The calculation unit may calculate the reliability of the first result by using an existing technique such as factual analysis that is a technique of analyzing whether an event actually happened. As an example, the calculation unit may calculate the reliability of the first result by using the first result and the document extracted by the extraction unit. As a method of calculating the reliability of the first result by the calculation unit using the first result and the document extracted by the extraction unit, (a) a method based on the distance between words, (b) a method based on the distance between documents, or (c) a method based on a learning model, is considered.

In the case of using a method based on the distance between words, the calculation unit calculates the reliability of the first result on the basis of the distance between words between each word included in the first result and each word included in the document. Specifically, the calculation unit first calculates the distance between words for each combination of each word included in the first result and each word included in the document. The calculation unit calculates the reliability of the first result in such a manner that the reliability of the first result is higher as the calculated distance between words is shorter.

In the case of using a method based on the distance between documents, the calculation unit calculates the reliability of the first result on the basis of the distance between documents between a sentence included in the first result and a sentence included in the document. Specifically, the calculation unit first calculates the distance between documents between a sentence included in the first result and a sentence included in the document. The calculation unit calculates the reliability of the first result in such a manner that the reliability of the first result is higher as the calculated distance between documents is shorter.

In the case of using a method based on a learning model, the calculation unit uses a learning model that is trained by machine learning to input two sentences therein and output the similarity of the two sentences. In this case, the calculation unit inputs, to the learning model, a sentence included in the first result and a sentence included in the document. Then, the calculation unit calculates the reliability of the first result in such a manner that the reliability of the first result is higher as the similarity output from the leaning model is higher.

When there are a plurality of documents extracted by the extraction unit, the reliability of the first result is calculated for each of the documents. Then, the calculation unit may calculate the arithmetic mean value of the calculated reliabilities as the reliability of the first result.

As another example, the calculation unit may calculate the reliability by using the first result, the document extracted by the extraction unit, and the text acquired by the acquisition unit. For example, the calculation unit may calculate the reliability with reference to a result of inputting the first result, the document extracted by the extraction unit, and the text acquired by the acquisition unit into the language model used by the generation unit. As an example, the calculation unit acquires an index indicating to what degree the first result referring to the document is correct, as a reply to the first text, from the language model. The calculation unit calculates the reliability of the first result in such a manner that the reliability of the first result is higher as the output result is more positive (for example, as the value of the index is larger). With such a configuration, the calculation unit can suitably calculate the reliability of the first result by using the language model from which the first result is generated.

The calculation unit may input the first result, the document extracted by the extraction unit, and the text acquired by the acquisition unit, to the language model a number of times. In that case, the calculation unit may score the result output from the language model with respect to each of the plurality of inputs (likelihood, positive frequency, or the like), and calculate the reliability of the first result in such a manner that the reliability of the first result is higher as the score is higher.

Instead of the text acquired by the acquisition unit, in view of the document specified by the information added by the output control unit, the calculation unit may input text instructing to answer whether or not the first result is correct, into the language model. Even in that case, the calculation unit calculates the reliability of the first result in such a manner that the reliability of the first result is higher as the output result is more positive.

The determination unit determines whether or not a value exceeds a threshold. As an example, the determination unit determines whether or not the reliability calculated by the calculation unit exceeds a threshold. The determination unit stores the determination result in the storage unit in association with the reliability.

As described above, the information processing device that constructs the generative AI performs natural language processing using a language model with respect to the second text in which the first text is rewritten by using the acquired document related to the first text. Therefore, the information processing device can prevent the language model from executing natural language processing with reference to documents in which correctness of the content is unclear such as documents with low authenticity, documents with unclear authenticity, and documents whose source is unclear, and can generate an answer only with reference to highly reliable sentences. Therefore, the information processing device can improve the reliability of the answers made by using the language model.

Moreover, the information processing device outputs a result in which information specifying the document related to the first text is added to the result of performing natural language processing with respect to the second text by the language model. Therefore, the information processing device can present the result of performing natural language processing and information of the document referred to in the natural language processing, to the user. Accordingly, the information processing device can present the reliability of the natural language processing performed by using the language model, to the user.

Note that generation of a checklist by the checklist generation unit 13 can be realized by using the generative AI similarly to the above description. In that case, the generative AI has been applied with machine learning so as to output a checklist in response to an input of a draft document or a related document in advance. Similarly, generation of reason for return by the return reason presenting unit 14 can be realized by using the generative AI. In that case, the generative AI has been applied with machine learning so as to output reason for return in response to an input of an inadequate part or a related document with respect to a draft document in advance. Similarly, generation of a correction proposal by the correction proposal unit 15 can be realized by using the generative AI. In that case, the generative AI has been applied with machine learning so as to output a correction proposal in response to an input of an inadequate part, an inadequate content, reason for inadequacy, or a related document with respect to the draft document in advance.

### [Operation]

Next, operation of the document preparation support device 10 will be described with reference to the drawings.

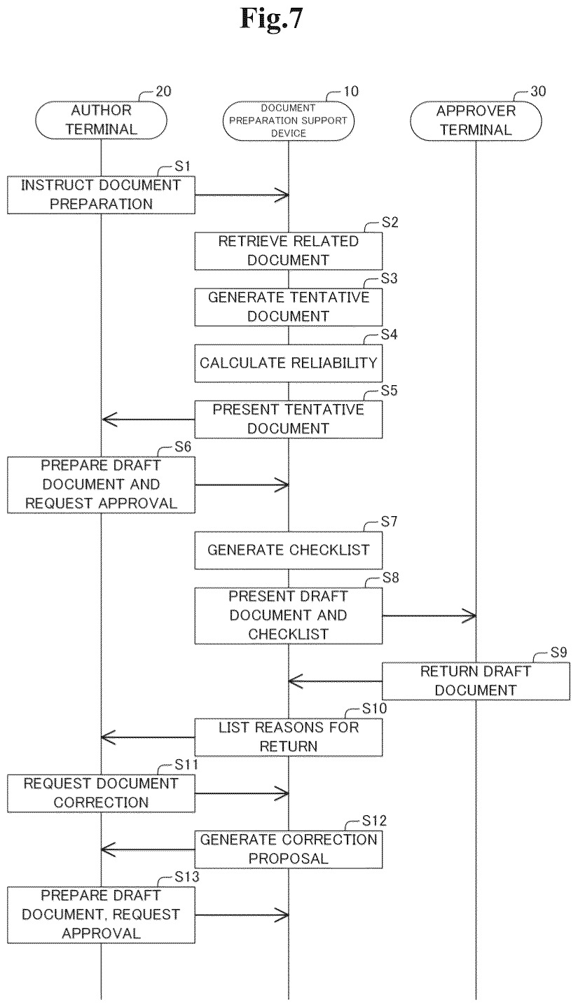

First, an author such as an administrative staff member determines to draft an administrative document, and inputs a document preparation command from the author terminal 20 (step S1 in FIG. 7). At this time, the document preparation command from the author terminal 20 includes keywords consisting of text related to a case subject to document preparation. For example, in the case of planning preparation of an administrative document as illustrated in FIG. 2, a document preparation command such as “preparing a document related to new park construction plan” or “preparing a plan for constructing a new park” is input, and “new park construction”, “new park”, and the like in the command are included as keywords.

Then, the document retrieval unit 11 of the document preparation support device 10 that received the document preparation command from the author terminal 20 retrieves a related document corresponding to the keyword included in the document preparation command from among the related documents including past cases and materials stored in the related document storage unit 16 (step S2 in FIG. 7). For example, the document retrieval unit 11 retrieves administrative documents such as “central library renovation plan” or “new public swimming pool construction plan” used in the past according to the keyword, from among the related documents as illustrated in FIG. 3.

Then, the document generation assisting unit 12 of the document preparation support device 10 generates a tentative document of the administrative document to be prepared, on the basis of the document preparation command and the retrieved related document (step S3 in FIG. 7). At this time, the document generation assisting unit 12 generates a tentative document corresponding to the document preparation command by using a past administrative document or a template that is a retrieved related document. The document generation assisting unit 12 may input the document preparation command and the retrieved related document to the generative AI generated through machine learning in advance and acquire a tentative document output from the generative AI to generate the tentative document.

At this time, the document generation assisting unit 12 may give and output reliability of the generated tentative document (step S4 in FIG. 7). For example, the document generation assisting unit 12 calculates the similarity between the content of the retrieved related document and the content of the generated tentative document as reliability.

Then, the document generation assisting unit 12 outputs the generated tentative document so as to display it on the display device of the author terminal 20 (step S5 in FIG. 7). At this time, the document generation assisting unit 12 outputs the generated tentative document so as to display it on the display device of the author terminal 20 in association with the information related to the retrieved related documents (source, laws/regulations, statistical materials, or the like) and the reliability described above.

After the tentative document is displayed on the author terminal 20 in this manner, the author prepares a draft document with reference to the tentative document (step S6 in FIG. 7). At this time, the author can prepare a draft document while correcting the tentative document by referring to the related documents associated with the tentative document or referring to the reliability. Then, the author requests approval of the prepared draft document from the author terminal 20 to the approver terminal 30 via the document preparation support device 10 (step S6 in FIG. 7). At this time, when requesting approval, the author terminal 20 makes a request for approval by transmitting the related document associated with the tentative document and the prepared attached document in association with the prepared draft document, to the document preparation support device 10.

Then, the checklist generation unit 13 of the document preparation support device 10 receives a request for approval of the draft document from the author terminal 20 to the approver terminal 30, and generates a checklist of the draft document on the basis of the content of the draft document (step S7 in FIG. 7). At this time, the checklist generation unit 13 may generate a checklist on the basis of additional information related to the correction such as a past correction record and correction comments attached to the related document associated with the draft document, or generate a checklist by extracting check items preset according to the text in the draft document. The checklist generation unit 13 may input the draft document and the related document to the generative AI generated through machine learning in advance and acquire a checklist output from the generative AI to generate the checklist.

Then, the checklist generation unit 13 outputs the generated checklist together with the draft document so as to display them on the display device of the approver terminal 30 (step S8 in FIG. 7). Then, the approver checks the draft document with reference to the checklist. At that time, the approver can check the draft document with reference to the related document associated with the draft document or attached materials attached thereto, together with the checklist.

Then, when there is no inadequacy in the draft document through the check of the draft document, the approver performs processing to approve the draft document by the approver terminal 30. On the contrary, when there is any inadequacy in the draft document, the approver performs processing to point out the inadequate part by the approver terminal 30 and performs processing to return the draft document (step S9 in FIG. 7). For example, the approver inputs the inadequate part (indicated part) by designating the text corresponding to the inadequacy in the draft document by the approver terminal 30, also inputs the inadequate content by the words describing the inadequate content with respect to the inadequate part, and performs operation of return processing of the draft document. As a result, the approver terminal 30 generates a return document containing the inadequate part and the inadequate content of the draft document, transmits it together with the draft document to the document preparation support device 10, and requests return to the author terminal 20.

The return reason presenting unit 14 of the document preparation support device 10 that received the return request from the approver terminal 30 generates reason for return describing the reason and background of the inadequacy with respect to the inadequate part and the inadequate content in the draft document that is a return document (step S10 in FIG. 7). At this time, the return reason presenting unit 14 generates the reason for return including the reason for inadequacy or laws/regulations and articles with respect to the inadequate item corresponding to the part to which the additional information is attached, from the content of additional information related to the correction such as a past correction record, correction comments, and relates articles attached to the related document, with reference to the related document of the draft document subject to return. The return reason presenting unit 14 may input the return document and the related documents to the generative AI generated through machine learning in advance and acquire reason for return output from the generative AI to generate the reason for return.

Then, the return reason presenting unit 14 outputs the generated reason for return including the reason for inadequacy or laws/regulations and articles together with the draft document so as to display them on the display device of the author terminal 20 (step S10 in FIG. 7). As a result, the author corrects the draft document with reference to the reason for return by the author terminal 20. At this time, the author may request a correction proposal to the draft document on the basis of the reason for return, from the author terminal 20 to the document preparation support device 10 (step S11 in FIG. 7). In response to it, the correction proposal unit 15 of the document preparation support device 10 generates a correction proposal corresponding to the reason for inadequacy included in the reason for return (step S12 in FIG. 7). For example, the correction proposal unit 15 generates a correction proposal corresponding to the reason for inadequacy, with reference to the additional information related to correction such as a past correction record, correction comments, and related articles in the related document associated with the draft document. Then, the correction proposal unit 15 transmits the generated correction proposal to the author terminal 20.

Then, the author corrects the draft document with reference to the correction proposal by the author terminal 20, and requests approval of the draft document (step S13 in FIG. 7). As described above, since an approval request of the draft document is given from the author, the processing of step S6 and after in FIG. 7 is repeated. Then, when it is confirmed that there is no problem in the draft document by the approver, the approval processing is performed by the approver terminal 30, and the document is formally adopted.

As described above, the document preparation support device 10 of the present embodiment first retrieves related documents according to the document preparation command by the author, and generates a tentative document based on the related documents. Moreover, the document preparation support device 10 prepares a checklist to be used by the approver with respect to the draft document generated from the tentative document by the author. Therefore, the author can prepare a draft document easily, and the approver can check the draft document easily with reference to the checklist. As a result, it is possible to make the process from drafting to settlement efficient even in the case of a document requiring accuracy such as an administrative document.

Further, the document preparation support device 10 also generates reason for return with respect to return by the approver. As a result, efforts of the approver when returning the document can be reduced, and the author can easily recognize the reason for return. As a result, it is possible to make document preparation more efficient.

Moreover, the document preparation support device 10 provides the author with information of related documents and the reliability of a tentative document by attaching them to the tentative document, when preparing the tentative document. As a result, preparation of a draft document by the author can be made more easily, so that it is possible to make document preparation more efficient.

### Second Example Embodiment

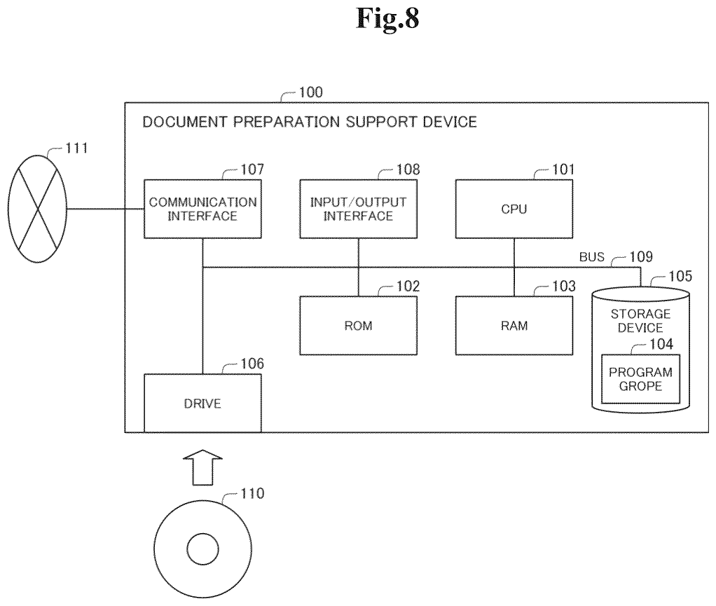

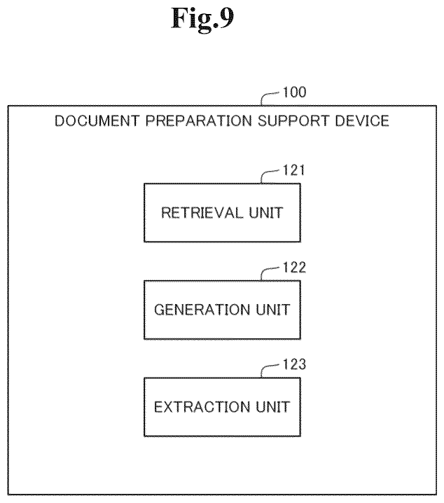

Next, a second example embodiment of the present disclosure will be described with reference to the drawings. The present embodiment shows the outlines of the configuration of the document preparation support device explained in the above-described embodiment. Note that FIGS. 8 and 9 are diagrams for explaining the configuration, which may be related to any embodiments.

First, a hardware configuration of an document preparation support device 100 will be described with reference to FIG. 8. The document preparation support device 100 is configured of a typical information processing device, having a hardware configuration as described below as an example.
Central Processing Unit (CPU) 101 (arithmetic device)
Read Only Memory (ROM) 102 (storage device)
Random Access Memory (RAM) 103 (storage device)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the respective constituent elements

Note that FIG. 8 illustrates an example of a hardware configuration of an information processing device that is the document preparation support device 100. The hardware configuration of the information processing device is not limited to that described above. For example, the information processing device may be configured of part of the configuration described above, such as without the drive 106. Moreover, instead of the CPU, the information processing device may use a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof.

The document preparation support device 100 can construct, and can be equipped with, a retrieval unit 121, a generation unit 122, and an extraction unit 123 illustrated in FIG. 9 through acquisition and execution of the program group 104 by the CPU 101. Note that the program group 104 is stored in the storage device 105 or the ROM 102 in advance, and is loaded to the RAM 103 and executed by the CPU 101 as needed. Further, the program group 104 may be provided to the CPU 101 via the communication network 111, or may be stored on the storage medium 110 in advance and read out by the drive 106 and supplied to the CPU 101. However, the retrieval unit 121, the generation unit 122, and the extraction unit 123 may be constructed by dedicated electronic circuits for implementing such means.

The retrieval unit 121 retrieves a related document corresponding to text included in a document preparation command input by an author. Then, the generation unit 122 generates a tentative document based on the document preparation command and the retrieved related document. Further, on the basis of the content of a draft document generated from the tentative document by the author, the extraction unit 123 extracts check items to be reviewed by a document reviewer in the draft document.

Since the present disclosure is configured as described above, a tentative document is generated based on the related document retrieved according to the document preparation command by the author. Therefore, the author can easily prepare a more accurate draft document by using such a tentative document. Moreover, since a checklist with respect to the draft document is prepared, the document reviewer can easily review the draft document with reference to the checklist. As a result, it is possible to make the process from drafting to settlement efficient even in the case of a document requiring accuracy such as an administrative document.

Note that at least one of the functions of the retrieval unit 121, the generation unit 122, and the extraction unit 123 described above may be carried out by an information processing device provided and connected to any location on the network, that is, may be carried out by so-called cloud computing.

The program described above can be stored in a non-transitory computer-readable medium of any type and supplied to a computer. Non-transitory computer-readable media include tangible storage media of various types. Examples of non-transitory computer-readable media include magnetic storage media (for example, flexible disk, magnetic tape, and hard disk drive), magneto-optical storage media (for example, magneto-optical disk), a CD-ROM (Read Only Memory), a CD-R, a CD-R/W, and semiconductor memories (for example, mask ROM, PROM (Programmable ROM), EPROM (Erasable PROM), flash ROM, and RAM (Random Access Memory)). The program may be supplied to a computer by a transitory computer-readable medium of any type. Examples of transitory computer-readable media include electric signals, optical signals, and electromagnetic waves. A transitory computer-readable medium can supply a program to a computer via a wired communication channel such as a wire and an optical fiber, or a wireless communication channel.

While the present disclosure has been described with reference to the example embodiments described above, the present disclosure is not limited to the above-described embodiments. The form and details of the present disclosure can be changed within the scope of the present disclosure in various manners that can be understood by those skilled in the art. Moreover, the example embodiments may be combined with other example embodiments as appropriate.

### Supplementary Notes

The whole or part of the example embodiments disclosed above can be described as the following supplementary notes. Hereinafter, outlines of the configurations of a document preparation support device, a document preparation support method, and a program, according to the present disclosure, will be described. However, the present disclosure is not limited to the configurations described below.

### (Supplementary Note 1)

A document preparation support device comprising:
a retrieval unit that retrieves a related document corresponding to text included in a document preparation command input by an author;
a generation unit that generates a tentative document on a basis of the document preparation command and the retrieved related document; and
an extraction unit that, on a basis of a content of a draft document generated from the tentative document by the author, extracts a check item to be reviewed by a document reviewer in the draft document.

### (Supplementary Note 2)

The document preparation support device according to supplementary note 1, further comprising
a reason generation unit that, with respect to an indicated part pointed out in the draft document by the document reviewer according to the extracted check item, generates reason for pointing out on a basis of a content of the indicated part.

### (Supplementary Note 3)

The document preparation support device according to supplementary note 2, further comprising
a correction proposal unit that generates a correction proposal to the draft document on a basis of the reason for pointing out.

### (Supplementary Note 4)

The document preparation support device according to supplementary note 1, wherein
the retrieval unit retrieves the related document that is a document used in a past case, on a basis of the text, and
the generation unit generates the tentative document on a basis of a content of the retrieved related document and the document preparation command.

### (Supplementary Note 5)

The document preparation support device according to supplementary note 1, wherein
the retrieval unit retrieves the related document that is a document used in a past case, on a basis of the text, and
the extraction unit extracts the check item in the draft document on a basis of additional information related to correction of the related document included in the retrieved related document and a content of the draft document.

### (Supplementary Note 6)

The document preparation support device according to supplementary note 2, wherein
the retrieval unit retrieves the related document that is a document used in a past case, on a basis of the text, and
the reason generation unit generates the reason for pointing out on a basis of additional information related to correction of the related document included in the retrieved related document and a content of the indicated part.

### (Supplementary Note 7)

The document preparation support device according to supplementary note 1, wherein
the generation unit outputs, to the author, information related to the retrieved related document in association with the tentative document.

### (Supplementary Note 8)

The document preparation support device according to supplementary note 1, wherein
the generation unit calculates reliability of the tentative document on a basis of a content of the retrieved related document and a content of the tentative document, and outputs the reliability to the author in association with the tentative document.

### (Supplementary Note 9)

A document preparation support method comprising:
retrieving a related document corresponding to text included in a document preparation command input by an author;
generating a tentative document on a basis of the document preparation command and the retrieved related document; and
on a basis of a content of a draft document generated from the tentative document by the author, extracting a check item to be reviewed by a document reviewer in the draft document.

### (Supplementary Note 10)

The document preparation support method according to supplementary note 9, further comprising,
with respect to an indicated part pointed out in the draft document by the document reviewer according to the extracted check item, generating reason for pointing out on a basis of a content of the indicated part.

### (Supplementary Note 11)

The document preparation support method according to supplementary note 10, further comprising
generating a correction proposal to the draft document on a basis of the reason for pointing out.

### (Supplementary Note 12)

The document preparation support method according to supplementary note 9, further comprising:
retrieving the related document that is a document used in a past case, on a basis of the text; and
generating the tentative document on a basis of a content of the retrieved related document and the document preparation command.

### (Supplementary Note 13)

The document preparation support method according to supplementary note 9, further comprising
retrieving the related document that is a document used in a past case, on a basis of the text, and
extracting the check item in the draft document on a basis of additional information related to correction of the related document included in the retrieved related document and a content of the draft document.

### (Supplementary Note 14)

The document preparation support method according to supplementary note 10, further comprising:
retrieving the related document that is a document used in a past case, on a basis of the text; and
generating the reason for pointing out on a basis of additional information related to correction of the related document included in the retrieved related document and a content of the indicated part.

### (Supplementary Note 15)

The document preparation support method according to supplementary note 9, further comprising
outputting, to the author, information related to the retrieved related document in association with the tentative document.

### (Supplementary Note 16)

The document preparation support method according to supplementary note 9, further comprising
calculating reliability of the tentative document on a basis of a content of the retrieved related document and a content of the tentative document, and outputting the reliability to the author in association with the tentative document.

### (Supplementary Note 17)

A program for causing a computer to execute the processing to:
retrieve a related document corresponding to text included in a document preparation command input by an author;
generate a tentative document on a basis of the document preparation command and the retrieved related document; and
on a basis of a content of a draft document generated from the tentative document by the author, extract a check item to be reviewed by a document reviewer in the draft document.

### REFERENCE SIGNS LIST

10 document preparation support device
11 document retrieval unit
12 document generation assisting unit
13 checklist generation unit
14 return reason presenting unit
15 correction proposal unit
16 related document storage unit
20 author terminal
30 approver terminal
100 document preparation support device
101 CPU
102 ROM
103 RAM
104 program group
105 storage device
106 drive
107 communication interface
108 input/output interface
109 bus
110 storage medium
111 communication network
121 retrieval unit
122 generation unit
123 extraction unit

1. A document preparation support device comprising:
at least one memory configured to store instructions; and
at least one processor configured to execute instructions to:
retrieve a related document corresponding to text included in a document preparation command input by an author;
generate a tentative document on a basis of the document preparation command and the retrieved related document; and
on a basis of a content of a draft document generated from the tentative document by the author, extract a check item to be reviewed by a document reviewer in the draft document.

2. The document preparation support device according to claim 1, wherein the at least one processor is configured to execute the instructions to,
with respect to an indicated part pointed out in the draft document by the document reviewer according to the extracted check item, generate reason for pointing out on a basis of a content of the indicated part.

3. The document preparation support device according to claim 2, wherein the at least one processor is configured to execute the instructions to
generate a correction proposal to the draft document on a basis of the reason for pointing out.

4. The document preparation support device according to claim 1, wherein the at least one processor is configured to execute the instructions to:
retrieve the related document that is a document used in a past case, on a basis of the text; and
generate the tentative document on a basis of a content of the retrieved related document and the document preparation command.

5. The document preparation support device according to claim 1, wherein the at least one processor is configured to execute the instructions to:
retrieve the related document that is a document used in a past case, on a basis of the text, and
extract the check item in the draft document on a basis of additional information related to correction of the related document included in the retrieved related document and a content of the draft document.

6. The document preparation support device according to claim 2, wherein the at least one processor is configured to execute the instructions to:
retrieve the related document that is a document used in a past case, on a basis of the text; and
generate the reason for pointing out on a basis of additional information related to correction of the related document included in the retrieved related document and a content of the indicated part.

7. The document preparation support device according to claim 1, wherein the at least one processor is configured to execute the instructions to
output, to the author, information related to the retrieved related document in association with the tentative document.

8. The document preparation support device according to claim 1, wherein the at least one processor is configured to execute the instructions to
calculate reliability of the tentative document on a basis of a content of the retrieved related document and a content of the tentative document, and outputs the reliability to the author in association with the tentative document.

9. A document preparation support method comprising:
retrieving a related document corresponding to text included in a document preparation command input by an author;
generating a tentative document on a basis of the document preparation command and the retrieved related document; and
on a basis of a content of a draft document generated from the tentative document by the author, extracting a check item to be reviewed by a document reviewer in the draft document.

10. The document preparation support method according to claim 9, further comprising,
with respect to an indicated part pointed out in the draft document by the document reviewer according to the extracted check item, generating reason for pointing out on a basis of a content of the indicated part.

11. The document preparation support method according to claim 10, further comprising
generating a correction proposal to the draft document on a basis of the reason for pointing out.

12. The document preparation support method according to claim 9, further comprising:
retrieving the related document that is a document used in a past case, on a basis of the text; and
generating the tentative document on a basis of a content of the retrieved related document and the document preparation command.

13. The document preparation support method according to claim 9, further comprising
retrieving the related document that is a document used in a past case, on a basis of the text, and
extracting the check item in the draft document on a basis of additional information related to correction of the related document included in the retrieved related document and a content of the draft document.

14. The document preparation support method according to claim 10, further comprising:
retrieving the related document that is a document used in a past case, on a basis of the text; and
generating the reason for pointing out on a basis of additional information related to correction of the related document included in the retrieved related document and a content of the indicated part.

15. The document preparation support method according to claim 9, further comprising
outputting, to the author, information related to the retrieved related document in association with the tentative document.

16. The document preparation support method according to claim 9, further comprising
calculating reliability of the tentative document on a basis of a content of the retrieved related document and a content of the tentative document, and outputting the reliability to the author in association with the tentative document.

17. A non-transitory computer-readable medium storing thereon a program comprising instructions for causing a computer to execute the processing to:
retrieve a related document corresponding to text included in a document preparation command input by an author;
generate a tentative document on a basis of the document preparation command and the retrieved related document; and
on a basis of a content of a draft document generated from the tentative document by the author, extract a check item to be reviewed by a document reviewer in the draft document.
